(19) United States
(12) Patent Application Publication
(10) Pub. No.: US 2025/0258382 A1
(43) Pub. Date: Aug. 14, 2025

(54) Optical Beam Forming

(71) Applicant: COLDQUANTA UK LIMITED, Warwick (GB)

(72) Inventors: Timothy BALLANCE, Warwick (GB); Nathan BENTALL, Warwick (GB); David BOWMAN, Warwick (GB); Oliver CORFIELD, Warwick (GB); Ryan HANLEY, Warwick (GB); Cornelis RAVENSBERGEN, Warwick (GB); Isaac SCHNELLING, Warwick (GB)

(21) Appl. No.: 19/052,986

(22) Filed: Feb. 13, 2025

(30) Foreign Application Priority Data
Feb. 14, 2024 (GB) 2402049.7

(51) Int. Cl. G02B 27/30; G02B 27/14

(52) U.S. Cl. CPC G02B 27/30; G02B 27/14

(57) ABSTRACT

An optical beam-forming apparatus including: a chassis supporting a plurality of component units, having a collimation lens unit to produce a collimated beam of light from the input light; a polarisation control unit to impose a pre-set minimum degree of linear polarisation upon the collimated beam of light; a beam splitter unit to extract a monitoring portion of light from the collimated beam of light; wherein the chassis is shaped to support each one of the collimation lens unit, the polarisation control unit and the beam splitter unit so as to secure their respective positions in a mutual coaxial alignment along an optical axis of the beam-forming apparatus; and, a beam monitoring unit to receive the monitoring portion of light and to produce a monitoring signal corresponding to an optical intensity thereof according to the optical intensity of the monitoring portion of light.

### CROSS REFERENCE TO RELATED APPLICATIONS

This application is filed under 35 U.S.C. 111 (a), and claims priority to United Kingdom Application No. GB2402049.7, filed Feb. 14, 2024 the content of which is incorporated by reference herein.

### FIELD OF THE INVENTION

The present invention relates to an optical apparatus arranged for forming an optical beam or beams suitable for use in manipulating cold atoms or molecules, and/or in cooling atoms or molecules, e.g. such as to form cold atoms or molecules. In particular, although not exclusively, the invention relates to optical beam-forming apparatus for use in cold-atom devices such as (but without limitation to) magneto-optical traps (MOTs), such as 2-dimensional (2D) or 3-dimensional (3D) MOTs. The present invention relates particularly, although not exclusively, to the launching of optical beams for controlling and/or manipulating individual atoms, molecules or Bose-Einstein condensates (BEC) thereof.

### BACKGROUND

The temperature of a gas depends upon the speeds of the particles forming the gas. This relationship underpins the concept of laser cooling of gasses. Mechanical forces between a laser beam and the moving atoms in a gas are used to slow the atoms in a gas and thereby produce very low gas temperatures. Gas temperatures achievable by laser cooling may be a few micro-Kelvins. This corresponds to atomic speeds around ten thousand times smaller than when the gas is at room temperature. An important property of laser-cooled gas is that gas particles only weakly interact with each other. This makes it possible to observe low-temperature quantum effects. In the following, reference is made to atoms of a gas, and it is to be understood that the following also applied to molecules of a gas, as would be readily understood by the skilled person.

The technique of laser cooling exploits the condition in which the frequency of a laser beam is set close to resonance with an energy difference between two energy levels within the atoms of the gas. This allows transitions of the quantum states of atoms of gas being cooled. An atom of gas moving in the +x direction with a velocity vₓ is caused to interact with a counter-propagating laser beam of light having a frequency f which is close to resonance with one of the allowed quantum transitions of the atom: f=ω+δ, in which w is the frequency of a photon required to achieve the quantum transition in the atom, and δ<<ω is a small frequency detuning. As seen from the perspective (inertial frame) of the atom, the source of the laser light moves with a relative velocity (vₓ) towards the atom. Due to the Doppler effect, the frequency of the laser light (photon energy) is shifted to a frequency f′ in proportion to that relative velocity:

$${f}^{′} = f ( 1 + {v}_{x} / c ) ∼ ω + δ + ω [ {v}_{x} / c ] .$$

If the value of δ is selected so that δ=−ω [vₓ/c], where cis the speed of light in vacuum, then f′=ω. Under these conditions the laser is in resonance with an atomic transition of the atoms within the gas moving in the +x direction. Thus, when a gas atom absorbs a photon from the laser, it is excited to an excited quantum state for a short period of time and subsequently returns to the original un-excited quantum state by emitting a photon spontaneously in a random direction.

Each time this quantum transition cycle is repeated, a net change (Δp) in momentum of the atom occurs in the +x direction. This net change is equal to the momentum of the initially absorbed photon, which is given by: Δp=−h/λ, where his Planck's constant and A is the wavelength of the laser light. The absorption of the photon, and therefore the momentum change, is always in the −x direction. However, importantly, the momentum change experienced by an atom caused by the subsequent spontaneous photon emission averages-out to zero. This is because the direction of spontaneous photon emission is random. The slowing force imposed upon atoms by the cooling laser beam, is equal to the rate of change of momentum experienced by an atom. This is given by the momentum change per absorption-emission cycle, multiplied by the rate of such cycles. Accordingly, repeated photon absorption-emission cycles generate a net slowing force in the −x direction, which reduces the velocity of gas atoms in the +x direction.

However, this Doppler cooling process begins to become ineffective when the detuning required for cooling becomes comparable to the natural line width (Δf) of the atomic transition in question. As a consequence, the minimum thermal energy of the atom approximately equal to hΔf. This means that the minimum temperature (T) will be about: T˜hΔf/k_{B}, where k_{B} is Boltzmann's constant.

Laser cooling with a single laser beam is effective when the laser detuning (o) is larger than the line width (Δf) of the atomic transition. However, as the atoms cooled down, the necessary detuning becomes comparable to the line width and atoms moving in the −x direction then experience an accelerating force which cancels the slowing force experienced by atoms moving in the +x direction. The increased speed of the former atoms reheats the latter atoms by inter-atomic collisions.

### Optical Molasses

One application of laser cooling is the so-called ‘optical molasses’ technique. To achieve lower temperatures, two counter-propagating laser beams are directed upon the atoms to be cooled. A first laser imparts a frictional force F₊ on an atom, whereas the counter-propagating second laser imparts a frictional force F₋ on the atom. In this situation, the atom experiences separate forces from each laser with a net force being:

$${{F}_{x} = {F}_{+} + F}_{-}$$

When the laser is tuned to the condition required for cooling, identified above, then F₋>>F₊ for atoms moving in the +x direction at high temperatures/velocities, and F₊>>F₋ for atoms moving in the −x direction at high temperatures/velocities. In this way, the two laser beams are able to cool atoms moving in opposite directions. As the atoms cool, and their velocities fall, the net force imposed on an atom by the two counter-propagating laser beams, is given by:

$${F}_{x} = - β \vert {v}_{x} \vert$$

This is a damping force (i.e. negative sign) which applies equally whatever the direction (+/−) of the velocity of the atom. The motion of the cold atoms is damped in both x-directions. As a result, an arrangement of two counter-propagating laser beams, described above, is commonly known as “optical molasses”. This technique is often applied in three dimensions, using six laser beams. This makes the atoms slow but it does not completely reduce their velocity to zero. As a result, the atoms do not remain stationary and consequently are not trapped by this technique alone.

Magneto-Optical Atomic and/or Molecular Cooling

As described above, an optical molasses arrangement provided by two counter-propagating laser beams provides optical cooling only along the axis of laser beam counter-propagation (the x-direction [+/−]). To provide optical cooling along multiple orthogonal axes requires a pair of counter-propagating laser beams along each of the orthogonal axes in question (e.g. x-direction, y-direction, z-direction). This will enable atoms to be cooled/stopped in respect of multiple velocity components (x; y; z directions [+/−]).

However even such two-dimensional or three-dimensional optical molasses does not have the ability to trap cooled atoms at the same location in space, and so is not effective in generating a concentration of cooled atomic gas. The addition of a magnetic field provides this means of concentration, when used in conjunction with the optical molasses described above. This combination is generally known as a magneto-optical trap (MOT) arrangement.

A typical type of three-dimensional MOT comprises six laser beams consisting of three pairs of counter-propagating beams, arranged to converge at a location corresponding to the centre of a magnetic quadrupole field which creates an attractive potential for atomic states with M>0. This achieves atomic cooling of all three velocity components within the magnetic trapping region where the cooling beams converge. Alternatively, a two-dimensional MOT may omit one of the three pairs of counter-propagating beams thereby achieving atomic cooling in two of the three orthogonal velocity components within the magnetic trapping region where the cooling beams converge, while simultaneously allowing cooled atoms to be ejected/pushed from the cooling region in a direction along the third of the three orthogonal velocity components.

The magnetic quadrupole field is typically generated using two coils carrying currents flowing in opposite directions. The magnitude of the quadrupole magnetic field produced by these coils has a minimum value at its centre, where the magnetic fields from the two individual coils mutually cancel. Applying a magnetic quadrupole field of the simple form B (z)=(0, 0, b·z) with b being the magnetic field gradient and z the spatial coordinate, leads to Zeeman-splitting of otherwise degenerate spin-state energy levels in an atom. For the ground spin state J=0 the energy remains undisturbed (no angular momentum) while for the excited state J′=1 the degeneracy is lifted by the non-zero value of the magnetic field at locations other than z=0.

The energy of a magnetic (Zeeman) sub-level of a spin state in a magnetic field Bis given by the magnetic interaction energy:

E=g_{L}μ_{B}MB

in which g_{L} is the Lande g-factor, and μ_{B} is the Bohr magneton and M is an integer (quantum number) for the different Zeeman sub-levels. Right-circular polarized light is able to drive atomic transitions to some split spin states when propagating in one direction along the z-axis, whereas left-circular polarized light is able to drive atomic transitions to the split spin states when propagating in the other (opposite) direction along the z-axis. This is due to the conservation of angular momentum. As a result, an atom bathed within two such counter-propagating laser beams will experience a net force pushing it towards the location z=0 where the magnetic field is zero and where the Zeeman splitting ceases. At position z=0, an atom feels no net force.

Atomic states having M>0 achieve their lowest energy when B is its smallest, whereas atomic states with M<0 achieve their lowest energy when Bis higher. Accordingly, the centre of a magnetic quadrupole field, where its minimum lies, is attractive for atomic states with M>0, but repulsive for atomic states with M<0. In this way, a magnetic field is used to compress a gas of cold atoms produced by the optical molasses effect, thereby increasing the density of the gas of cold atoms within the cooling region at the centre of the quadrupole field. This enables quantum effects such as Bose-Einstein condensation to be realised.

Accordingly, laser cooling beams may be used in conjunction with magnetic traps to provide magneto-optical traps (MOTs), such as 2-dimensional (2D) MOTs which use laser beams counter-propagating in the x direction [+/−] and the y direction [+/−], but not the z direction, or 3-dimensional (3D) MOTs which use laser beams counter-propagating in the x direction [+/−] and the y direction [+/−], and the z direction [+/−].

However, the optical apparatus employed to prepare, direct and control the multiple laser beams in 2D-MOTs and 3D-MOTs is large, expensive and typically bespoke or peculiar to the experimentalist who has created the MOT in question.

The present invention has been devised in light of the above considerations.

### SUMMARY OF THE INVENTION

In a first aspect, the invention may provide an optical beam-forming apparatus for forming a collimated beam of linearly polarised light from input light received thereby, the apparatus comprising:
a chassis supporting a plurality of component units, the plurality of component units comprising:
   a collimation lens unit configured to produce a collimated beam of light from the input light; a polarisation control unit configured to impose a pre-set minimum degree of linear polarisation upon the collimated beam of light; a beam splitter unit configured to extract a monitoring portion of light from the collimated beam of light; wherein the chassis is shaped to support each one of the collimation lens unit, the polarisation control unit and the beam splitter unit so as to secure their respective positions in a mutual coaxial alignment along an optical axis of the beam-forming apparatus; and,
   a beam monitoring unit configured to receive the monitoring portion of light and to produce a monitoring signal corresponding to an optical intensity thereof for use in monitoring an optical intensity of the collimated beam of light according to the optical intensity of the monitoring portion of light.

Accordingly, the chassis provides a shaping, such as a bore, a channel, a slot, a groove, a ridge, an edge, a notch, a tongue or the like, configured and dimensioned to engage with each one of the collimation lens unit, the polarisation control unit and the beam splitter unit so as to secure their respective positions in a mutual coaxial alignment along an optical axis of the beam-forming apparatus. The shaping of the chassis may extend in a direction parallel to the mutual optical axis formed by the collimation lens unit; polarisation control unit; the beam splitter unit. The collimation lens unit, the polarisation control unit, and the beam splitter unit may be configured to provide a reciprocal shaping configured and dimensioned to engage with the shaping of the chassis. For example, a reciprocal shaping may be configured and dimensioned to reciprocate a surface of the chassis in a manner such as, but not limited to, the following: a convex reciprocal shaping configured to reciprocate a concave surface of a bore of the chassis; a convex reciprocal shaping configured to reciprocate a channel or slot of the chassis; a convex reciprocal shaping (e.g., a tongue) configured to reciprocate a groove of the chassis; a concave reciprocal shaping configured to reciprocate a ridge, notch, tongue or edge of the chassis. By virtue of such physical/mechanical engagement between the chassis and the component parts of the beam-forming apparatus, a mutual optical alignment may be achieved accurately, easily and with few parts (thereby reducing cost).

The shaping of the chassis permits an optical alignment of the component parts to be assured by simply mounting, housing or otherwise engaging the component parts upon (or within) the chassis. There is no need for complex and expensive additional moving parts for enabling the mutual on-axis optical alignment to be achieved. The one-piece nature of the chassis also means that its shape and structure is fixed and is not subject to alteration, adjustment or variation as would otherwise be the case were the chassis formed of multiple parts connected together by connecting means such as screws, or the like. This allows a simplicity of design, and ease of manufacture of the apparatus and a consequential reduction in cost. The component parts can be aligned during manufacturing. As alignment is done during manufacturing, the various components may, if desired, be glued/secured into place. This may result in the end user having a reduced ability to configure the device, however, removing configurability aspects allows the components to be fit into a much smaller form factor, and is easy to setup and use. Pre-alignment of the system in manufacture permits a device with fewer parts, since fewer/no complex user-controlled alignment structures are required. A more compact plug-and-play device with no moving parts may be provided.

The chassis may take the form of a single piece. The term “single-piece” herein may include a reference to an entity consisting of or made in a single undivided piece. The chassis may comprise a single-piece housing within which is housed one or more of: the collimation lens unit; polarisation control unit; the beam splitter unit. For example, the housing may comprise a casing defining a bore within which these component parts of the beam-forming apparatus may be inserted and held in place by virtue of a mechanical engagement as between the shaping of the chassis (e.g., the bore itself may provide that shaping, or at least a part of the shaping) and the reciprocal shaping of the inserted component parts. The chassis may be shaped to provide an interface formation engaging simultaneously with a reciprocally-shaped interface formation provided by a respective shape of each one of the collimation lens unit, the polarisation control unit and the beam splitter unit. The interface formation may be shaped to define a bore (e.g., a through-bore) to a surface with which each of the respective reciprocally-shaped interface formations engage to position, respectively, the collimation lens unit, the polarisation control unit and the beam splitter unit in positions in succession along an axis of the bore. The chassis may include securing parts comprising one or more fixing rings configured to engage simultaneously with the bore and with at least one of the component units to secure the position(s) of the at least one component unit along the axis of the bore. The bore of the housing may be threaded (e.g., along its full length) to permit threaded one or more fixing ring to engage with the threading of the bore for adjustment of axial positioning of the fixing ring within the bore by rotation of the ring(s) relative to the bore. The apparatus may comprise one or more such fixing rings.

The polarisation control unit and/or the beam splitter unit may comprise an alignment groove formed in a surface thereof and extending in a direction parallel to the optical axis parallel to the axis of the bore of the housing, and a screw inserted into the chassis and configured to extend into the bore to enter and engage with the alignment groove to prevent rotational movement of the polarisation control unit and/or the beam splitter about the optical axis. This screw may also ensure that the polarisation control unit and/or the beam splitter unit can only be inserted in the correct orientation.

The housing may comprise a window aligned in to place the monitoring unit in optical communication with the beam-splitter unit such that the extracted monitoring portion of light from the collimated beam of light may pass therethrough. The housing may comprise a PCB attached to a surface thereof bearing the monitoring unit. The monitoring unit may comprise an amplified photodiode configured to produce the monitoring signal in the form of an electrical voltage signal. This reduces signal noise and removes the need to provide an amplifier externally.

The optical beam-forming apparatus may be configured for receiving the input light from an optical fibre and may comprise a terminated fibre adapter unit secured to the chassis and configured for connecting to a pre-terminated end of an optical fibre to secure an output end of the optical fibre to the chassis.

The polarisation control unit may be disposed or located between the collimator unit and the beam splitter unit for receiving the collimated beam of light from the collimator unit, for imposing said pre-set minimum degree of linear polarisation thereupon, and for directing a linearly-polarised collimated beam of light to the beam splitter unit. The value of the pre-set minimum degree of linear polarisation may be at least 95%, or at least 99%, or at least 99.5%. A degree of linear polarisation, P, of a beam of light comprising light of intensity I_{⊥} that is polarised in a plane perpendicular to a reference plane, and also comprising light of intensity I_{∥} that is polarised in a plane parallel to the reference plane, may be defined in the following way, as would be readily apparent to a person of ordinary skill in the art:

$$P = \frac{{I}_{⊥} - {I}_{‖}}{{I}_{⊥} + {I}_{‖}}$$

The beam splitter unit may be disposed or located after the collimator unit and the polarisation control unit for receiving the collimated beam of light from the collimator unit, for extracting the monitoring portion of light in the desired linear polarisation. The beam splitter unit may comprise a cube beam-splitter. The beam splitter unit may comprise a non-polarising cube beam-splitter.

The beam splitter unit may be configured to receive the linearly polarised collimated beam of light for splitting thereof into two linearly polarised collimated sub-beams of light of pre-set relative optical intensities, the two sub-beams comprising a first sub-beam corresponding to the monitored portion of light and a second sub-beam corresponding to the monitoring portion of light for detection. The beam monitoring unit may be configured to receive the second sub-beam and to output the detection signal corresponding to an optical intensity of the second sub-beam, for monitoring an optical intensity of the first sub-beam according to the optical intensity of the second sub-beam.

In this way, the intensity of the second sub-beam may be monitored and stabilized or otherwise controlled as desired according to the detection signal. The use of a cube beam-splitter to generate the first sub-beam for use in generating the detection signal has been found by the inventors be have negligible, very low, or at least acceptably low, detriment to the quality of the second sub-beam. It is believed that this may be due to the suppression of parasitic optical reflections which suppress optical effects that may otherwise damage beam quality in terms of its intensity distribution (in cross-section) and the purity of its state of linear polarisation.

The collimation lens unit may define an optical axis along which the beam of collimated light extends, and the cube beam-splitter may comprise a partially reflective internal beam-splitting optical surface inclined between two external optical faces of the cube beam-splitter both of which may be substantially perpendicular to the optical axis. This orientation also is believed to suppress the onset of parasitic optical reflections (internal) between outer cube surfaces.

The technical benefits of suppression of parasitic optical reflections, at least in terms of the purity of the state of linear polarisation of an optical beam for injection into a vacuum chamber of a cold-atom apparatus (e.g. a MOT chamber) are set out below to allow a better appreciation of the importance of this.

The optical beam-forming apparatus may be applied to any one or more of the following uses (this is not intended to be an exhaustive list), all of which benefit from the suppression of parasitic optical reflections noted above, and discussed below:
Ionizing atoms to create ions;
Driving atomic transitions to generate fluorescence to observe/measure the atoms;
Cooling the motion of atoms by driving atomic transitions in a particular configuration;
Trapping atoms, either in combination with a magnetic field in a MOT, or via an optical dipole trap (ODT);
State preparation/optical pumping, to prepare an atom or sample of atoms in a specific quantum state;
State manipulation, coherent control of the prepared quantum state.

### Polarisation Control and Atomic Transitions

In the following discussion, reference is made to the schematic drawing of FIG. 10 which assists in explaining the importance of carefully controlling the linear polarisation and, ultimately, the circular polarisation state of the optical beams input into, for example the vacuum chamber of a 3D-MOT (and also the optical beams input into the 2D-MOT). Polarisation control is also important in other applications such as coherent manipulation of atomic states. This is to ensure that the photons within the optical beams possess the necessary angular momentum quantum number in order to allow them to preferentially access desired and appropriate atomic transitions to atomic energy states.

Circularly polarised optical beams may typically be formed by passing a linearly-polarised optical beam through a circular polariser configured to receive an optical beam to convert the polarisation thereof from a state of linear polarisation to a state of circular polarisation. The provision of accurate and precise circular polarisation has the advantage of permitting control over the relative rates of atomic/molecular transitions occurring in atoms/molecules by absorption of circularly polarised photons of light from the optical beam in question. This may be advantageous in 2D-MOT and 3D-MOT processes. The circular polariser may comprise a quarter-wave plate configured to receive the optical beam and to impose upon it a circular polarisation.

Referring to FIG. 10, the ‘on-axis’ direction, is the direction which is along the symmetry axis passing through the centre of both anti-Helmholtz coils of a MOT. The ‘off axis’ direction is the direction perpendicular to this, which also passes through the centre of the trapping region. Both counter-propagating beams have the same polarisation. In the following discussion, it is assumed that the on-axis B-field is pointing outwards and the off-axis B-field (in the median plane between the coils) is pointing inwards (this can be reversed by changing the direction of the current).

At point ‘a’, and ‘on-axis’, the following conditions prevail:
The photon k-vector of the left-hand optical beam and the local anti-Helmholtz magnetic ‘B-field’ point in opposite directions. The left-hand beam has a clockwise polarisation and this means that the beam drives a σ− atomic transition as schematically illustrated at the bottom of the figure (left-hand schematic).
The photon k-vector of the right-hand optical beam and the local anti-Helmholtz magnetic ‘B-field’ point in the same direction. The right-hand beam has a clockwise polarisation and this means that this beam drives a σ+ atomic transition as schematically illustrated at the bottom of the figure (right-hand schematic).

Due to the Zeeman shift, the left-hand beam is closer to resonance with m_{F}=−1 atomic transition than the right-hand beam is with m_{F}=+1 atomic transition there. As a consequence, atoms at point ‘a’ absorb more photons from the left-hand beam than from the right-hand beam and thus tend to move towards the centre of the trap.

At point ‘b’, and ‘on-axis’, the following conditions prevail:
The photon k-vector of the right-hand optical beam and the local anti-Helmholtz magnetic ‘B-field’ point in opposite directions. The right-hand beam has a clockwise polarisation and this means that the beam drives a σ− atomic transition as schematically illustrated at the bottom of the on-axis figure (right-hand schematic).
The photon k-vector of the left-hand optical beam and the local anti-Helmholtz magnetic ‘B-field’ point in the same direction. The left-hand beam has a clockwise polarisation and this means that this beam drives a σ+ atomic transition as schematically illustrated at the bottom of the on-axis figure (right-hand schematic).

Again, the atoms are brought towards the centre of the trap.

At point ‘a’, but this time ‘off-axis’, the following conditions prevail:
The photon k-vector of the left-hand optical beam and the local anti-Helmholtz magnetic ‘B-field’ are pointing in the same direction, and the left-hand optical beam has anti-clockwise polarisation so that it drives σ− atomic transitions.
The photon k-vector of the right-hand beam and the local anti-Helmholtz magnetic ‘B-field’ point in opposite direction, and right-hand beam has an anti-clockwise polarisation so that it drives σ+ atomic transitions.

At point ‘b’, again ‘off-axis’, the following conditions prevail:
The photon k-vector of the right-hand beam and the local anti-Helmholtz magnetic ‘B-field’ point in the same direction, and right-hand beam has anti-clockwise polarisation so that it drives σ− atomic transitions.
The photon k-vector of the left-hand beam and the local anti-Helmholtz magnetic ‘B-field’ point in opposite direction. The left-hand beam has anti-clockwise polarisation so that it drives σ+ atomic transitions.

Again, the atoms are brought towards the centre of the trap.

Accordingly, by controlling the circular polarisation states of photons injected into the 2D-MOT and the 3D-MOT, one is able to preferentially access appropriate atomic (Zeeman) transitions applications adjacent to the trap centre in such a way that the atoms experiencing those atomic transitions are urged towards the trap centre. Given that circular polarisation states are typically generated using linearly polarised optical beams, the purity of the linear polarisation state of the optical beam affects the purity of the circular polarisation state generated form it. Suppression of parasitic optical reflections assists in achieving good-quality optical beams in this sense at least, as well as in other senses discussed herein.

The optical beam-forming apparatus may comprise a housing through which a continuous bore (e.g., a through-bore) extends containing the collimation lens unit, the polarisation control unit, and the beam splitter unit each being received therein to collectively define a mutual optical axis for transmission of the beam of collimated light along the bore. An axis of the bore may thereby coincide with the mutual optical axis. This arrangement has been found to permit easier and cheaper manufacture/assembly of preferably a small optical beam forming apparatus.

The bore may comprise a circular cross section defining a bore surface with a radius of curvature. The collimation lens unit, the polarisation control unit, and the beam splitter unit may each comprise respective outer surface parts possessing the radius of curvature therewith forming a contact interface (e.g., a sliding interface) with the bore surface permitting positional adjustment thereof axially along (e.g. by sliding along) the mutual optical axis and/or adjustment thereof azimuthally about (e.g., by rotation about) the mutual optical axis. This arrangement has been found to permit reliable optical alignments to be obtained relatively easily during manufacture/assembly of the optical beam-forming apparatus.

The housing may comprise a fibre-optic adaptor unit for receiving an output end of an optical fibre and for fixing the position thereof relative to the fibre-optic adaptor unit. The fibre-optic adaptor unit may comprise a terminated fibre adapter unit secured to the chassis and configured for connecting to a pre-terminated end of an optical fibre to secure an output end of the optical fibre to the chassis. The position of the fibre-optic adaptor unit may be adjustable in directions transverse to the bore and/or may be adjustable azimuthally about the optical axis to adjust the position of the output end of an optical fibre to align with the mutual optical axis. This arrangement has been found to permit reliable optical alignments to be obtained relatively easily during manufacture/assembly of the optical beam-forming apparatus. The polarisation control unit may define a polarisation transmission axis via which a state of polarisation is imposed on light transmitted through it. For example, a polarisating beam-splitter cube comprising a polarising partially reflective surface for reflecting light only of a first polarisation state (e.g., S-state) and for transmitting light only of a second (orthogonal) polarisation state (e.g., P-state), or a polarising filter for transmitting only one linear polarisation state (e.g., P-state). Azimuthal adjustment also permits accurate alignment of an axis of linear polarisation of the light (which may typically be polarised laser light) relative to (i.e., sympathetic to) a polarisation transmission axis of the polarisation control unit.

The collimation lens unit may define an optical axis along which, in use, the beam of collimated light extends, and the polarisation control unit may comprise a polarising beam-splitter cube comprising a polarisation-dependent reflective internal optical surface inclined between two external optical faces of the polarising beam-splitter cube both of which are substantially perpendicular to the optical axis. The orientation of the fibre-optic adaptor unit may be adjustable azimuthally about the optical axis relative to the polarisation-dependent reflective internal optical surface. The orientation of the polarisation-dependent reflective internal optical surface may be adjustable azimuthally about the optical axis, or may be azimuthally constrained by a mechanical alignment means configured to pre-set the azimuthal alignment and to prevent adjustment azimuthally (e.g., an alignment formation, such as an axially extending groove for receiving an alignment lug permitting axial adjustment but preventing azimuthal adjustment). These arrangements have each been found to permit reliable optical alignments to be obtained relatively easily during manufacture/assembly of the optical beam forming apparatus.

The beam monitoring unit may comprise a photodiode for receiving the second sub-beam and for generating an electrical current signal in response thereto, and an amplifier unit configured to receive the electrical current signal and to generate a voltage signal in response thereto, and to output the result as the detection signal. Amplification to a voltage signal has been found to permit signal transmission over greater distances with less noise incurred (i.e., improved signal-to-noise ratio).

The beam monitoring unit may comprise a Universal Serial Bus, USB, interface configured for receiving power from an external power source and for transmitting the detection signal to an external signal receiver. Preferably, the amplifier unit is powered by power received from the external power source via the same cable that delivers the detection signal to the external signal receiver.

The optical beam-forming apparatus may be configured to receive laser light from a laser unit and to form the beam of collimated light using the received laser light. The optical beam-forming apparatus may comprise a control unit for receiving the detection signal from the beam monitoring unit and for generating a laser control signal according to the received detection signal, for controlling an optical power output of the laser unit. The control unit may be remote from the optical beam forming apparatus and in communication with it via the USB interface. The control unit may include the eternal signal receiver. A USB cable may connect the control unit in communication with the optical beam-forming apparatus, for transmission of detection signals from the optical beam-forming apparatus to the control unit.

The control unit may be configured to provide power to the beam monitoring unit. The USB cable may connect the control unit in communication with the optical beam-forming apparatus, for transmission of power to the optical beam-forming apparatus from the control unit.

The optical beam-forming apparatus may comprise the laser unit. The optical beam-forming apparatus may comprise an optical fibre (e.g., a polarisation-maintaining optical fibre) connecting the laser unit in optical communication with the collimation lens unit to provide the optical input thereto.

In a second aspect, the invention may provide a system comprising a plurality of optical beam-forming apparatuses as disclosed herein, and further comprising:
a plurality of respective lasers;
a control unit for receiving a plurality of detection signals from respective beam monitoring units and for generating a plurality of laser control signals according to the received detection signals for controlling an optical power output of respective laser units.

The system may further comprise a magnetic field apparatus for providing a magnetic field arranged to concentrate gas atoms or molecules cooled or manipulated using the optical beam-forming apparatus, wherein the plurality of the optical beam-forming apparatuses is for providing one or more pairs of counter-propagating optical beams of light for manipulating cold atoms or cold molecules, and wherein the magnetic field and the one or more pairs of counter-propagating optical beams of light create a magneto-optical trap (MOT). The system may thereby provide a MOT device, configured for creating a MOT.

In a third aspect, the invention may provide a magneto-optical trap (MOT) device comprising an optical beam-forming apparatus as disclosed herein. The MOT device may comprise the system disclosed above, for example.

In a fourth aspect, the invention may provide a cold atom source comprising a magneto-optical trap (MOT) device as disclosed herein. The source may comprise the system disclosed above, for example.

Typically, the velocity of a “cold atom” would be ‘thermally distributed’ around a target velocity according to the temperature of the atom cloud. The term “cold atom” when used in this specification, includes a reference to the temperature of the “cold atoms” in question being less than 1 (one) Kelvin (K), or preferably not greater than about 100 μK. Desirably, the temperature of the “cold atoms” in question is not greater than 10 μK. The term “cold molecule” may also be understood in this way. For example, an atom or molecule, respectively, which has a kinetic energy (E) sufficiently small that the equivalent thermal temperature (T) of the atom or molecule (i.e. according to: E=(3/2)kT, where k is Boltzmann's constant) has a value which is less than 1 (one) Kelvin (K), or preferably not greater than about 100 μK, or more preferably not greater than 10 μK. However, the disclosures herein are not limited to this interpretation of the term “cold atom” and the term “cold molecule”, unless otherwise indicated. The optical beam forming apparatus may be configured to manipulate (e.g., as part of a cooling process or otherwise) atoms or molecules in or for a ‘cold atom apparatus’.

A “cold atom source” is a source of “cold atoms” with a suitably well-defined velocity such that the population is appropriate for use in a “cold atom sensor”. The well-defined velocity may, for example, be as close as practicable to 0 m/s (zero m/s) for stationary atoms coming from a stationary molasses phase, or ‘x’ m/s for atoms which are moving in unison in a controlled direction as would be the case after a ‘moving molasses phase’. The term “cold atom source” when used in this specification, may be understood to include reference to a source of such atoms, and to a source that provides atoms which cooled to have thermal velocity distributions with characteristic temperature not greater than 100 μK. For example, a thermal distribution of rubidium (Rb87) atoms at a temperature of 100 μK will cause the “cold atoms” to have a velocity standard deviation (velocity spread) of about 66.0 mm/s. A typically velocity that may be used to launch the “cold atoms” collectively through an MOT may be about 1 m/s. Thus, a typical velocity of a group of “cold atoms” collectively would be about 1.0±0.07 m/s.

The invention, in a further aspect, may provide an “cold atom source” comprising an optical beam-forming apparatus, or a magneto-optical trap (MOT), as described above. In other words, the invention may provide a cold atom source for a so-called “cold atom sensor”, to use a terminology known in the art. In a yet further aspect, the invention may provide a “cold atom sensor” comprising such a cold atom source.

The invention includes the combination of the aspects and preferred features described except where such a combination is clearly impermissible or expressly avoided.

### BRIEF DESCRIPTION OF THE DRAWINGS

Embodiments and experiments illustrating the principles of the invention will now be discussed with reference to the accompanying figures in which:

FIG. 1A shows a perspective view of an optical beam-forming apparatus.

FIG. 1B shows a schematic view of an optical beam-forming apparatus.

FIG. 1C shows a schematic cross-sectional view of an optical beam-forming apparatus.

FIGS. 2A and 2B show an end view (FIG. 2A) of the optical beam-forming apparatus of FIG. 1, and a cross-sectional view (FIG. 2B) of the optical beam-forming apparatus of FIG. 1.

FIG. 2C shows an exploded view of an optical beam-forming apparatus of FIG. 1.

FIG. 3 shows a schematic diagram of parts of the optical beam-forming apparatus of FIG. 1.

FIG. 4 schematically shows a polarising beam-splitter cube.

FIG. 5 schematically shows a non-polarising beam-splitter cube.

FIG. 6 schematically shows a beam-splitter plate.

FIG. 7 shows a perspective view of part of an optical beam-forming apparatus of FIG. 1.

FIG. 8 shows a schematic view of a control system comprising three optical beam-forming apparatuses of FIG. 1.

FIG. 9A shows a perspective view of a control unit and power unit of the control system of FIG. 9.

FIG. 9B shows a circuit diagram of an amplified photodiode of the optical beam former unit.

FIG. 10 schematically shows the atomic transitions driven by circularly polarised photons at locations within an anti-Helmholtz magnetic field for the purposed of a 2D-MOT and a 3D-MOT.

FIG. 11 shows an exemplary 3D-MOT optical and magnetic field delivery package.

### DETAILED DESCRIPTION OF THE PREFERRED EMBODIMENTS

Aspects and embodiments of the present invention will now be discussed with reference to the accompanying figures. Further aspects and embodiments will be apparent to those skilled in the art. All documents mentioned in this text are incorporated herein by reference.

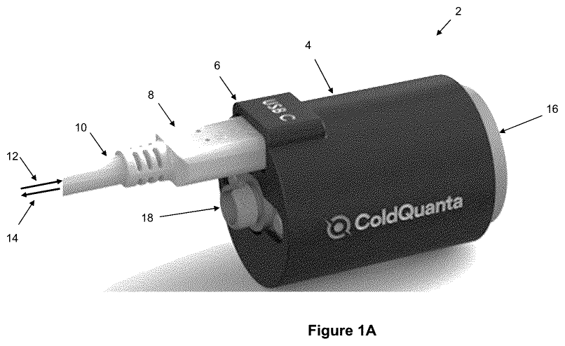

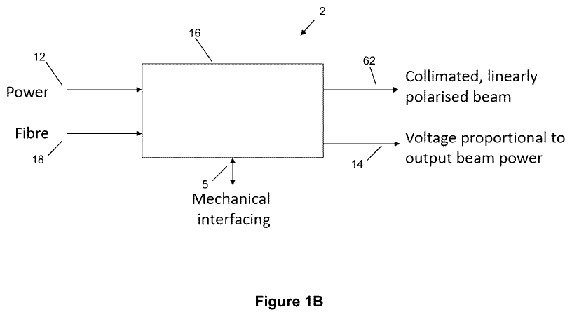

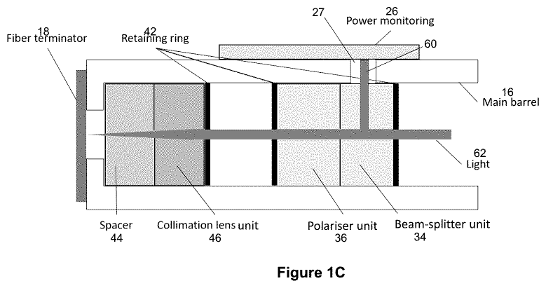

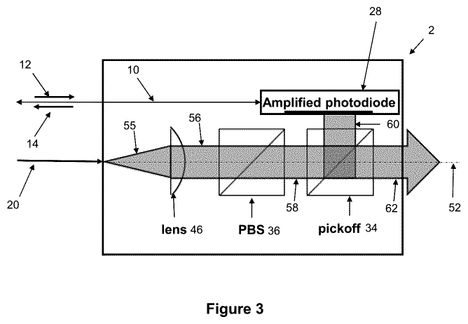

FIGS. 1, 2A, 2B, 2C and 3 respectively show a perspective view, an end view, a cross-sectional view and a schematic view, of an optical beam-forming apparatus (see item 2 of FIG. 1) configured to form a beam of light. The beam of light may be used, for example, for manipulating cold atoms or cold molecules in a vacuum chamber, e.g., a vacuum chamber of a magneto-optical trap or a vacuum chamber of any other device for manipulating cold atoms (not shown). However, it is to be understood that the use of the optical beam-forming apparatus is not limited to this.

FIGS. 1B and 1C show schematic views of the optical beam-forming apparatus in a more general form. In general terms, the apparatus 2 comprises a single-piece chassis 16 supporting a plurality of component units including a collimation lens unit configured to produce a collimated beam of light from light input into the apparatus from an external light source (e.g., a laser), a polarisation control unit configured to impose a pre-set minimum degree of linear polarisation upon the collimated beam of light, and a beam splitter unit configured to extract a monitoring portion of light from the collimated beam of light. These component units are discussed in examples herein, in more detail. The chassis is shaped to support each one of the collimation lens unit, the polarisation control unit and the beam splitter unit so as to secure their respective positions in a mutual coaxial alignment along an optical axis of the beam-forming apparatus. A beam monitoring unit is also supported on the chassis and is configured to receive the monitoring portion of light and to produce a monitoring signal corresponding to an optical intensity thereof for use in monitoring an optical intensity of the collimated beam of linearly-polarised light 62 that is output by the optical beam-forming apparatus, according to the optical intensity of the monitoring portion of light. The monitoring signal may be output as a voltage signal 14 for use in controlling the external light source, for example. The beam monitoring unit is powered by power 12 input to the apparatus from a remote power supply. Light is input into the apparatus, from which the output optical beam is formed, via an optical fibre 18, for example.

FIG. 1C shows a general example of an arrangement in which the chassis 16 takes the form of a housing barrel unit defining a barrel shaped to form a bore (e.g., a through-bore) for securely holding the collimation lens unit 46, the polarisation control unit 36 and a beam splitter unit 34 in mutual optical alignment along the axis of the bore. The outer surface parts of the collimation lens unit 46, the polarisation control unit 36 and a beam splitter unit 34 are shaped in a way that reciprocates the shape of the bore of the chassis 16 such that a close-fitting mechanical interface or abutment is formed between the bore surface and the component parts to securely position the component parts upon the axis of the bore and the optical axis of the apparatus. In other words, the components parts are held by the barrel, within its bore, to prevent them from shifting off-axis, whereas their position along the optical axis may be adjusted/selected as desired. The chassis 16 thereby forms a housing in the shape of a barrel having a linear bore extending from an optical inlet end at which a terminated fibre adaptor 18 is mounted for coupling to an output end of an optical fibre, to an optical outlet end from which the collimated beam 62 of linearly polarised light exits. The bore of the barrel formed by the chassis 16 may be circular in cross-section, of uniform diameter, or may be another cross-sectional shape (e.g., square). Retaining rings 42 are positioned at selected longitudinal places along the bore of the barrel so as to restrain the longitudinal positions of the component parts such that the beam splitter unit 34 is optically aligned with a power monitoring unit 26 mounted to an outer surface of the barrel of the chassis 16, and in optical communication with the beam splitter unit 34 through a window 27 through which an extracted portion 60 of the optical beam 62 passes from the beam splitter unit 34 to the power monitoring unit 26. A spacer 44 is housed within the bore of the housing barrel 16 secures the desired longitudinal axial position of the collimation lens unit 46 relative to the optical inlet of the housing such that a desired divergence of the input light from the optical fibre may take place before reaching the collimator unit. This allows the collimated beam of light 62 to be formed with a desired beam width.

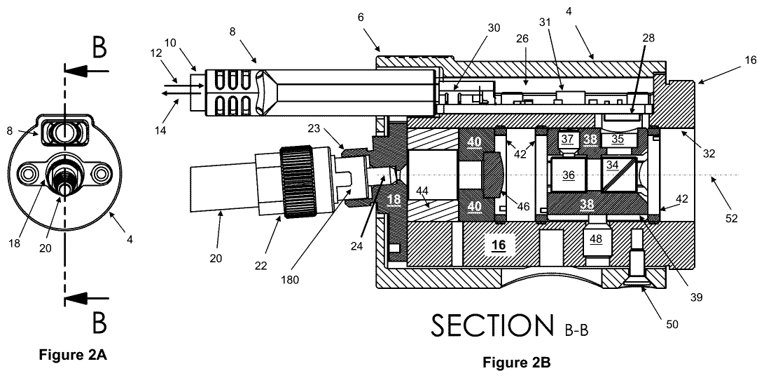

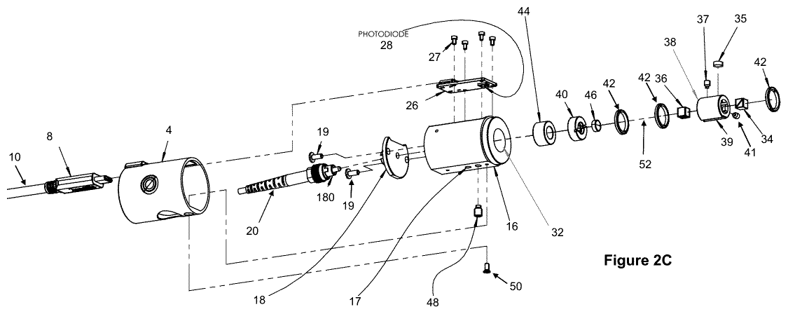

An example of a process of assembling the apparatus may comprise the following steps:
Load the spacer unit 44, of a desired axial length, into the bore of the barrel of the chassis (different spacer axial lengths enable different lenses to be used in the same barrel);
Glue a collimating lens to a lens mount thereby forming a collimation lens unit 46, and insert the unit into the barrel bore. Fix the axial position of the collimation lens unit in place against the spacer unit 44 with retaining ring 42 (these can be glued in place glued if required for adverse deployment);
Glue a polarizer and a beam-splitter cube into respective mounts thereby forming a polarisation control unit 36 and a beam splitter unit 34, and insert the units into the barrel bore. Fix the axial position of the units in place with retaining rings 42, (these can be glued in place glued if required for adverse deployment). An alignment feature (see FIG. 2C, item 39) may be provided on the polarisation control unit 36 and a beam splitter unit (which may be combined as one single-piece unit) in the form of a groove that fixes the radial orientation of the unit so that the monitoring beam 60 exits a window 27 in the barrel and is incident on the power monitoring unit 26;
Attach the power monitoring unit 26 onto the barrel of the chassis;
The fibre terminator/adaptor 18 is then attached to the inlet end of the barrel and can be moved radially to centre the optical beam.

Accordingly, the apparatus comprises a housing barrel unit 16 which houses optical and electronic components arranged upon a circuit board 26, discussed in more detail below, and is inserted within a sheath cover part 4. Opposite ends of the housing barrel unit 16 are exposed by the sheath cover part to reveal, at one end, an input/output socket port 6 of single cable interface (e.g., a USB-C interface in this example) 30 forming a part of the electronics housed by the housing barrel part 16 configured for receiving power from an external power source and for transmitting the detection signal to an external signal receiver, and an optical input port 18 unit comprising a fibre-optic cable connector 23 for receiving an optical output end 24 of a polarisation-maintaining optical fibre 20. The opposite exposed end of the housing barrel unit 16 comprises an optical output port in the form of the open end of a bore 32 of uniform cylindrical cross-sectional shape, that passes along the longitudinal axis of the housing barrel unit 16 from the optical input port to the optical output port and houses within it multiple optical components of the optical beam-forming apparatus along the bore axis of the bore 32 so as to define an optical axis 52 that is coincident with the bore axis, as discussed in more detail below.

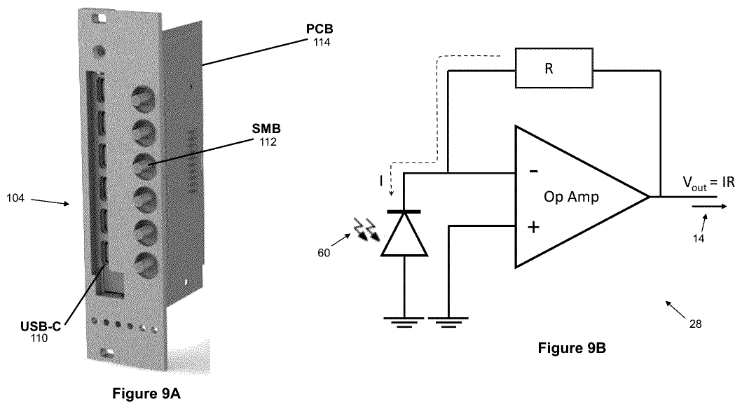

The input/output socket port 6 of a USB-C interface 30 is configured for receiving a USB-C connector plug 8 of a USB cable 10. The USB cable is configured to deliver power 12 into the electronic components 26 and to receive a detection output signal generated by an amplified photodetector 28 amongst the electronic components and to convey that detection signal 14 to a control unit (104, FIG. 9).

The multiple optical components of the optical beam-forming apparatus housed within the bore of the housing barrel unit, include a collimation lens unit comprising a collimating lens 46 configured to receive a divergent input beam of laser light 55 and therewith to form a beam of collimated laser light 56. The collimating lens comprises a converging lens of positive focal length, such as about 13 mm, arranged to form a collimated beam of laser light of about 2 mm diameter. In order to achieve this, the collimating lens 46 is spaced from the output end 24 of the polarisation-maintaining optical fibre 20 along the optical axis 52 by an axial spacing corresponding to the focal length of the collimating lens. This permits the divergent input beam of laser light 55 to diverge (conically) to a diameter coinciding with the diameter of the desired collimated beam.

The collimating lens 46 is mounted centrally within a lens mounting cartridge 40 that possesses a cylindrically convex outer surface shape with a radius of curvature matching the radius of curvature of the concave cylindrical surface of the bore. As a result, the outer cylindrical surface of the lens mounting cartridge forms an intimate sliding fit with the reciprocally-shaped bore surface of the bore. A lens spacer unit 44 comprises a bushing is positioned between, and in abutment with, both the lens mounting cartridge 40 and the optical input port 18 so as to maintain a pre-defined separation between the collimating lens and the optical input port. The lens spacer unit also possesses a cylindrically convex outer surface shape with a radius of curvature matching the radius of curvature of the concave cylindrical surface of the bore. Consequently, it too forms an intimate sliding fit with the reciprocally-shaped bore surface of the bore. A retaining ring 46 locks (reversibly) the lens mounting cartridge 40 and the lens spacer unit 44 securely in place within the bore by urging the lens mounting cartridge 40 against the opposing end surface parts of the lens spacer unit 44 which, in turn, urges opposite end surface parts of the lens spacer unit 44 against opposing surface parts of the optical input port 18 unit. The inner bore surface of the bore 32 is threaded with a threading configured to reciprocate a threading formed on the outer circumferential edge of the retaining ring 46 such that the retaining ring may be ‘screwed down’ onto an opposing surface of the lens mounting cartridge 40 thereby to generate the urging force described above.

The lens spacer unit 44, the lens mounting cartridge 40, and retaining ring 46 possess through-openings through which the diverging beam 55 and the collimated beam may pass through unobstructed.

The multiple optical components of the optical beam-forming apparatus housed within the bore of the housing barrel unit, also include a polarisation control unit in the form of a polarising beam-splitter (PBS) cube 36 configured to receive the beam of collimated light 56 and thereupon to impose a pre-set linear polarisation thereby to form a linearly polarised beam of collimated light 58. In addition, a beam splitter unit is provided in the form of a non-polarising beam-splitter cube 34 configured to receive the linearly polarised beam of collimated light 58 and to split it into two linearly polarised sub-beams of collimated light of pre-set relative optical intensities. A first sub-beam 62 passes undeflected through the non-polarising beam-splitter cube 34 for output into the vacuum chamber of a device for manipulating cold atoms (not shown), e.g., a vacuum chamber of a MOT. However, the second sub-beam 60 is deflected (‘picked-off’) for detection by the amplified photodetector 28 forming a part of the electronic components arranged upon a circuit board 26 and defining part of a beam monitoring unit 31 configured to receive the second sub-beam 60 and to output a detection signal 14 corresponding to an optical intensity of the second sub-beam. The detection signal 14 is then used for monitoring an optical intensity of the first sub-beam 62 according to the optical intensity of the second sub-beam 60. A focusing lens 35 is configured between the non-polarising beam splitter 34 and the amplified photodetector 28 for receiving the second sub-beam 60 and for focusing the received second sub-beam onto the photosensitive surface of the photodetector 28. This improves the signal-to-noise ratio of the detection signal produced by the photodetector 28 in response to the second sub-beam.

The polarising beam-splitter (PBS) cube 36 and the non-polarising beam-splitter cube 34 are both mounted centrally within the same one cube mounting cartridge 38 that possesses a cylindrically convex outer surface shape with a radius of curvature matching the radius of curvature of the concave cylindrical surface of the bore. As a result, the outer cylindrical surface of the cube mounting cartridge forms an intimate sliding fit with the reciprocally-shaped bore surface of the bore. A fixing screw 37 fixes polarising beam-splitter (PBS) cube 36 within the cube mounting cartridge, and a fixing screw 41 fixes non-polarising beam-splitter cube 34 within the cube mounting cartridge.

A pair of retaining rings 42 are positioned within the bore at locations spaced to be either end of the cube mounting cartridge, with a respective one ring of the pair of rings urged against one end of the cube mounting cartridge. These retaining rings collectively 42 lock (reversibly) the cube mounting cartridge securely in place within the bore by urging against a respective opposing end surface of the cube mounting cartridge to sandwich the cube mounting cartridge between the pair of mounting rings. The inner bore surface of the bore 32 is threaded, as noted above, with a threading configured to reciprocate a threading formed on the outer circumferential edge of each retaining ring 42 of the pair of retaining rings, such that each retaining ring may be ‘screwed down’ onto an opposing surface of the cube mounting cartridge 38 thereby to generate the urging force described above.

The cube mounting cartridge and each one of the pair of retaining rings 42 possess through-openings through which the collimated beam may pass through unobstructed.

An alignment screw 48, such as a dog-point grub screw, is removably mounted within a chamfered hole formed within the housing barrel unit 16. The chamfer of the chamfered hole engages with a shoulder formation on the outer cylindrical screw surface such that the alignment screw may be secured (removably) into the chamfered hole by ‘screwing down’ the shoulder formation onto the chamfer. The chamfered hole passes through the inner bore wall of the bore 32 such that a terminal end (e.g., the dog-point) of the alignment secured alignment screw enters into, and is in communication with, the bore so as to radially project into the bore. An alignment slot 39 is formed in an outer surface of the cube mounting cartridge 38 which extends along that outer surface in a direction parallel to the longitudinal axis of the cube mounting cartridge which, in turn, is parallel to the optical axis 52 of the beam-forming assembly 2. The projecting terminal end of the alignment 48 screw is dimensioned to form an intimate sliding fit with the alignment slot 39 such that the axial position of the cube mounting cartridge along the optical axis 52 may be slidingly adjusted, but such that the azimuthal position of the cube mounting cartridge about the optical axis, cannot be changed.

The alignment screw 48, the alignment slot 39, the polarising beam-splitter (PBS) cube 36, the non-polarising beam-splitter cube 34, the focusing lens 35 and the photodetector 28 all intersect a first plane containing the optical axis 52. The planes of the inclined reflective inner surfaces of the polarising beam-splitter (PBS) cube 36, the non-polarising beam-splitter cube 34 are both substantially perpendicular to the first plane. This ensures that the second sub-beam is accurately optically aligned with focusing lens 35 and the photodetector 28, and that the polarising axis of the polarising beam-splitter (PBS) cube 36 may be easily but accurately optically aligned simultaneously.

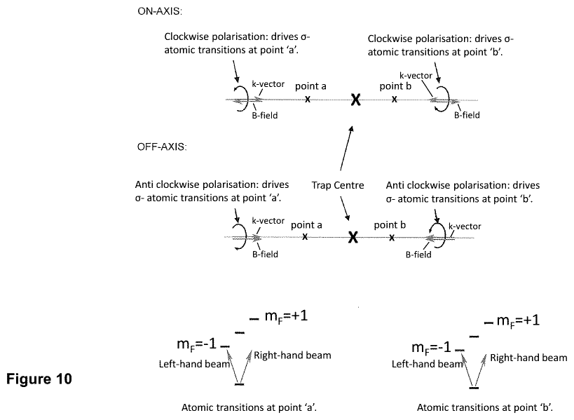

Accurate alignment of the optical components of the beam-forming apparatus along the optical axis is important for ensuring reliably good quality of the laser beams output by it for use in a device for manipulating cold atoms (not shown) downstream, e.g., for use in a MOT downstream. The beam quality required is both in terms of the intensity profile (in cross-section) across the beam and in terms of the purity of the linear polarisation state of the beam. Both of these beam qualities are important in enabling an accurate and reliable control of the atoms or molecules to be manipulated using light from the laser beam (or from multiple such laser beams) as discussed above with reference to FIG. 10.

The inventors have found that the use of beam-splitter cubes for within the beam-former is particularly reliable and effective in this regard and also permits the compact and simple design disclosed herein in terms of the ease and accuracy with which they can be mounted into the cube mounting cartridge, and the ease with which both the cube mounting cartridge and the lens mounting cartridge may be slidingly inserted coaxially into the bore of the housing barrel unit 16 with the necessary optical alignment along the optical axis. An appropriate azimuthal orientation of the cube mounting cartridge may be assured by use of the alignment slot (in conjunction with the alignment screw) formed along the cube-mounting cartridge such that appropriate azimuthal orientation of the optical cubes within the cube mounting cartridge is achieved. Similarly, an appropriate axial positioning if the collimating lens 46 may easily be achieved by sliding/inserting an appropriate lens spacer unit 44 up against which to abut the lens mounting cartridge 40 during assembly.

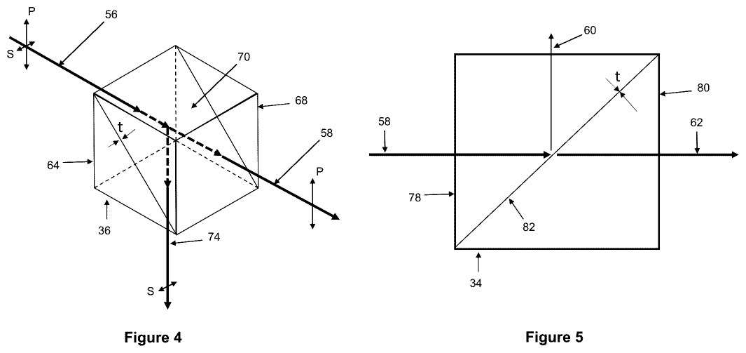

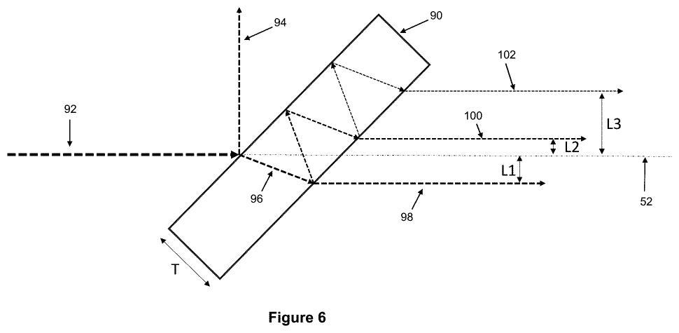

A beam-splitter is an optical device designed to split an incident light beam (e.g., a laser beam) into two beams, which may or may not have the same optical power (radiant flux). Two types of beam-splitters include: a plate beam-splitter such as schematically shown in FIG. 6, and a cube beam-splitter such as schematically shown in FIG. 4 and FIG. 5. The inventors have found that cube beam-splitters are far better at meeting the needs of mean quality required for use in a device for manipulating cold atoms (not shown), e.g., a MOT, as discussed above, than are plate beam-splitters.

FIG. 4 schematically shows a polarising beam-splitter cube, 36. FIG. 5 schematically shows a non-polarising beam-splitter cube 34.

A plate beam-splitter 90 as shown in FIG. 6 in receipt of an input light beam 92 will produce a reflected sub-beam 94 reflected from a partially reflective coating upon the leading surface of the plate, and a transmitted sub-beam 96 that passes through the reflective coating. However, because the plate possesses a back surface on the opposite side of the plate to the side bearing the reflective coating, the transmitted sub-beam 96 will always lead to multiple internal reflections resulting in multiple additional sub-beams (98, 100, 102) each having a transverse offset (L1, L2, L3) resulting in distortion of the net transmitted beam (98, 100, 102), which is proportional to the thickness, T, of the plate used. These so-called parasitic reflections from the back side of the plate that will lead to highly undesirable optical interferences and beam distortions and parasitic polarisation.

A laser beam is, in most cases, linearly polarized. A polarisation-maintaining optical fibre is an optical fibre configured to maintain the state of polarisation of a light beam input to it (e.g., a laser beam) such that the polarisation state of the light output from the optical fibre corresponds to the polarisation state of the light input to it (e.g., from the laser). Good control of the polarisation state of the light beams used in a MOT is critical for the accurate and reliable control of atomic transitions needed to manipulate atoms or molecules within the MOT chamber, as discussed above. The inventors have found that a well-defined state of polarisation is damaged by the effects of parasitic polarisation resulting from the parasitic reflections from the back side of a plate beam-splitter.

With a cube beam-splitter, by contrast, the beam separation occurs at an extremely narrow interface (70, 82) within the cube (FIG. 4 and FIG. 5). Such a cube is often made of two triangular glass prisms which are glued together with a transparent cement having a very small thickness, t, typically of the order of the wavelength of light in the beam being split. This thickness can be chosen to adjust the power splitting ratio for a given wavelength. Cube beam-splitters are typically constructed using two right angle prisms in which the hypotenuse surface of one prism is coated, and the two prisms are cemented together so that they form a cubic shape. A process of frustrated total internal reflection (FTIR) takes place within the hypotenuse interface whereby the evanescent wave of the incident light at the hypotenuse surface of one of the two triangular prisms, is able to extend across the interface gap, of very small thickness t, and couple to the hypotenuse surface of the other one of the two triangular prisms in a manner often compared to quantum tunnelling across the interface gap. The very small size of the interface gap effectively suppresses parasitic reflections.

FIG. 4 illustrates an example of the polarising beam splitter 36 within the cube-mounting cartridge 38, comprising two right angle prisms (64, 68) in which the hypotenuse surface of one prism is coated, and the two prisms are cemented together to form a partially reflective hypotenuse interface 70, of thickness t, so that they form a cubic shape. A polarized collimated beam of laser light 56 formed by collimating the polarised diverging light beam 55 provided by the polarisation maintaining optical fibre, possesses primarily a P-state of polarisation but with a small component of S-state polarisation. The partially reflective hypotenuse interface 70, reflects only the S-state component of the light incident upon it and transmits only the P-state of incident light such that the transmitted light beam 58 is substantially only composed of light in a P-state of polarisation. In this way, the polarising beam splitter 36 ‘cleans’ the collimated light beam of S-state components of the light. Maximal transmission into the transmitted beam 58 is possible by the accurate azimuthal orientation of the partially reflective hypotenuse interface 70 of the polarising beam splitter 36 so as to be sympathetic to the P-state polarisation axis of the collimated beam of laser light 56 which already possesses primarily a P-state of polarisation.

FIG. 5 illustrates an example of the non-polarising beam splitter 34 within the cube-mounting cartridge 38, comprising two right angle prisms (78, 80) in which the hypotenuse surface of one prism is coated, and the two prisms are cemented together to form a partially reflective hypotenuse interface 82, of thickness t, so that they form a cubic shape. A P-state polarized collimated beam of laser light 58 provided by the polarisation beam splitter 36, is input to the non-polarising beam splitter 34. The partially reflective hypotenuse interface 82, reflects only a small pre-set proportion (e.g., between 1% and 10%, by intensity) of the P-state light incident upon it and transmits the rest of the P-state incident light such that the transmitted light beam 62 is substantially only composed of light in a P-state of polarisation. In this way, the non-polarising beam splitter 34 ‘pick-off’ a small part of the collimated light beam of P-state light. The rest is transmitted for input to a MOT chamber.

The polarising beam-splitter cube comprises a polarisation-dependent reflective internal optical surface 70 inclined between two external optical faces of the polarising beam-splitter cube both of which are substantially perpendicular to the optical axis. This minimises the degree of reflection laser light as collimated beam of light enters and/or exits a given beam-splitter cube. It reduces the possibility of parasitic reflections, internally, between the two cube surfaces and the detrimental effects that can have on beam quality. The sliding contact interface of the cartridges with the bore surface permits positional adjustment thereof axially along the mutual optical axis and/or, in some examples, permits adjustment thereof azimuthally about the mutual optical axis.

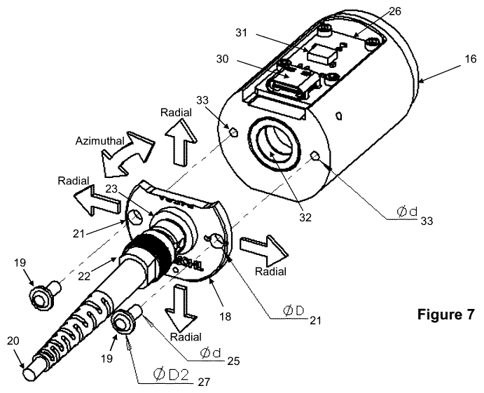

FIG. 7 shows a perspective view of part of an optical beam-forming apparatus of FIG. 1. The optical input port 18 unit comprises an adaptor plate through which the optical input port passes, including a fibre-optic cable connector 23 for receiving an optical output end 24 of a polarisation-maintaining optical fibre 20. Fixing screws 19 are used to adjust the concentricity of the fibre 20 with the optical axis 52 along the bore of the housing barrel unit 16.

Two through-holes 21 in the adaptor plate each have a diameter, D, which exceeds the diameter, d, of a threaded shaft 25 of a respective one of two fixing screws 19 configured to pass into the through-holes 21. Two threaded screw holes 33 are formed in the end surface of the housing barrel unit 16 against which the adaptor plate is configured to be secured to secure the received end 24 of the fibre-optic cable 20 in a desired position relative to the optical axis 52 of the system. The diameter, d, of each threaded screw holes 33 is configured to receive a threaded screw shaft 25 of a respective one of the two fixing screws 19. The diameter D2 of the screw head 27 of each fixing screw 19 exceeds the diameter D of the two respective through-holes 21 in the adaptor plate.

The adaptor plate may initially be loosely mounted upon the end surface of the housing barrel unit 16 by passing the shafts 25 of each one of the two fixing screws 19 through a respective one of the two through-holes 21 and screwing the treaded shafts into respective threaded screw holes almost, but not quite, fully tightened. In this partially tightened state, the position of the adaptor plate is able to be adjusted both radially and azimuthally about the optical axis along the housing barrel unit 16 so as to place the output tip of the optical fibre 20 in a desired position relative to the optical axis. Once positioned as desired, the fixing screws 19 may be fully tightened to fix that position of the adaptor plate. The position of the fibre-optic adaptor plate 18 is thereby adjustable in directions transverse to the bore and is adjustable azimuthally about the optical axis to adjust the position of the output end of an optical fibre to align with the mutual optical axis and/or to align with the orientation of the polarisation-dependent reflective internal optical surface azimuthally about the optical axis. Similarly, the non-polarising beam-splitter cube 34 comprises a polarisation-independent reflective internal optical surface 82 inclined between two external optical faces of the non-polarising beam-splitter cube both of which are substantially perpendicular to the optical axis. The orientation of the fibre-optic adaptor plate 18 is thereby adjustable radially and azimuthally about the optical axis relative to the polarisation-independent reflective internal optical surface 82.

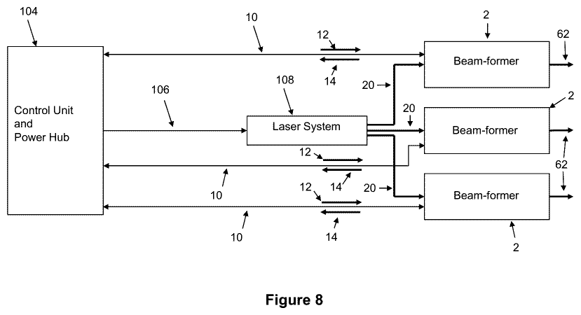

FIG. 8 shows a schematic view of a laser control system comprising three optical beam-forming apparatuses 2 of FIG. 1. In other examples, two optical beam formers 2 or more than three optical beam formers 2 may be used, but here three are illustrated for clarity and to explain a principle of a system employing a plurality of beam formers 2. The laser control system comprises the plurality of optical beam formers 2, each of which is arranged in electrical communication, via a respective USB-C cable 10, with a control unit and power hub 104 configured to providing, as a power hub, power 12 to each optical beam forming unit 2 and to receive therefrom, as a control system, a respective detection signal 14 and therefrom to generate a control signal 106 with which to control the optical output power provided by a laser system 108 to respective optical fibres 20 for input to respective optical beam forming units 2. In this way, a feed-back control loop is provided for each one of the plurality of optical beam formers 2 for stabilising the optical power output by a respective collimated light beam 62 output thereby.

The control unit comprises a processor configured to receive the detection signal 14 from a given optical beam former 2, to compare the magnitude of the voltage of the received detection signal to a pre-set reference value and to generate a control signal 106 according to the result of the comparison. The comparison may be performed by a comparator unit. For example, if the magnitude of the voltage of received detection signal exceeds the pre-set reference value, then a control signal 106 is generated to which the laser system 108 responds by reducing the output optical power it provides to the optical beam former from which the detection signal originated. By contrast, if the magnitude of the voltage of the received detection signal is less than the pre-set reference value, then a control signal 106 is generated to which the laser system 108 responds by increasing the output optical power it provides to the optical beam former from which the detection signal originated.

Each detection signal may be accompanied by an identifier data item that uniquely identifies the optical beam forming unit from which it originated, or may be structured or configured in a way that uniquely identifies the optical beam forming unit from which it originated. Methods for identifier data items such as would be readily apparent and available to the skilled person may be used to this end.

The laser system 108 may comprise a plurality of separate lasers equal in number to the plurality of optical beam forming units 2, such that each optical beam forming unit is supplied with laser light form a respective one of the plurality of lasers. In that case, a given control signal 106 generated in response to receipt of a detection signal from a given optical beam forming unit, may be directed to the laser that uniquely serves that given optical beam forming unit via a respective optical fibre 20.

Alternatively, the laser system may comprise one laser configured to provide a master laser beam, and an adjustable beam splitter system configured to split the master laser beam into a plurality of sub-beams of adjustable intensity, wherein each sub-beam is delivered, via an optical fibre 20, to a respective one of the plurality of optical beam forming units. In that case, a given control signal 106 generated in response to receipt of a detection signal from a given optical beam forming unit, may be directed to the adjustable beam splitter system to adjust the optical power of the sub-beam that uniquely serves that given optical beam forming unit via a respective optical fibre 20.

FIG. 9A shows a perspective view of a control and power unit 104 of the control system of FIG. 8. The control and power unit comprises a plurality of USB-C sockets 110 each for receiving a USB-C cable plug of a USB-C cable 10 from a respective one of the plurality of optical beam former units 2 of the laser control system. A circuit (not shown) is provided on a circuit board (PCB) 114 comprising a power supply (not shown) and a USB interface for receiving detection signals 14 from respective optical beam former units 2 and for transmitting power 12 from the power supply to respective optical beam former units 2 via the USB-C cable 10. The processor, (not shown) described above, is provided on the circuit board (PCB) 114, and is configured in communication with both the plurality of USB-C signal input sockets and a corresponding plurality of coaxial signal transmission ports (SMB connectors 112) for outputting RF control signals to respective laser units of the laser system to control the power output of those laser units. The laser system 108, in this example, comprises a plurality of separate lasers equal in number to the plurality of optical beam forming units 2, such that each optical beam forming unit is supplied with laser light form a respective one of the plurality of lasers. Thus, a given control signal 106 is transmitted to a respective laser unit via a respective one of the plurality of coaxial signal transmission ports 112, in response to receipt of a detection signal 14 at a respective one of the plurality of USB-C signal input sockets 110 from a respective one of the optical beam forming units. Each USB-C signal input socket 110 is paired with a respective one of the coaxial signal transmission ports 112 such that control signals are directed to the respective laser unit that uniquely serves the optical beam forming unit communicating with the control and power unit 104 via the paired USB-C signal input socket 110.

FIG. 9B shows a circuit diagram of the amplified photodiode of the optical beam former unit. The photodiode generates a current proportional to the intensity of light that strikes its active area. A transimpedance amplifier converts the photodiode current, I, into an output voltage, V. This circuit operates the photodiode in photovoltaic mode. The transimpedance amplifier comprises an operational amplifier with a feedback resistor, R, connected between the output terminal and the inverting input terminal of the operational amplifier. The cathode of the photodiode is connected to the inverting input terminal of the operational amplifier, and the anode of the photodiode is grounded, as is the non-inverting input terminal of the operational amplifier. Current flows from cathode to anode of the photodiode when light strikes the photodiode's active area. This photodiode current flows through the feedback resistor, R, generating an output voltage equal to the photodiode current multiplied by the feedback resistor's resistance value. This is the detection signal 14.

The invention may provide a method to form a beam of light (e.g., for manipulating cold atoms or cold molecules in a vacuum chamber (e.g., of a magneto-optical trap (MOT), for example, or other cold-atom apparatus), the method comprising the following steps:
Step 1: Receiving an input beam of light and therewith forming a collimated beam of light.
Step 2: Imposing upon the collimated beam of light a pre-set linear polarisation thereby to form a collimated beam of linearly polarised light.
Step 3: By a beam splitter unit comprising a non-polarising beam-splitter cube, splitting the collimated beam of linearly polarised light into two collimated sub-beams of linearly polarised light of pre-set relative optical intensities, the two sub-beams comprising a first sub-beam for output (e.g., for use as an input into the vacuum chamber (e.g., of the MOT, or other cold-atom apparatus) and a second sub-beam for detection. The first sub-beam corresponds to a monitored portion of light (i.e., light being monitored) and a second sub-beam corresponds to the monitoring portion of light for detection (i.e., the portion used to perform a monitoring function).
Step 4: Generating a detection signal corresponding to an optical intensity of the second sub-beam and therewith monitoring an optical intensity of the first sub-beam according to the optical intensity of the second sub-beam.

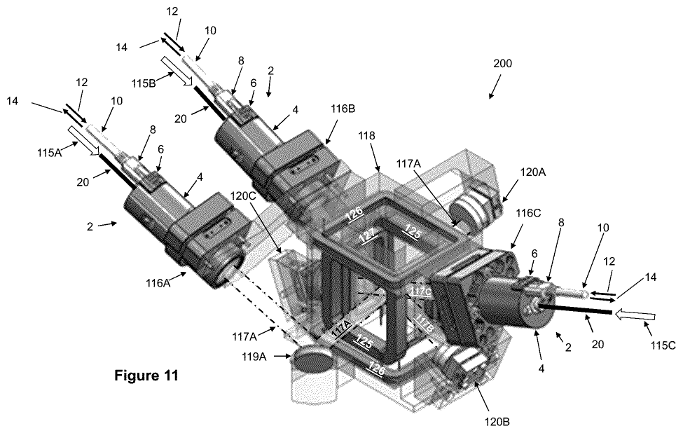

FIG. 11 shows an exemplary three-dimensional magneto-optical trap (3D-MOT) device 200. The 3D-MOT comprises three separate optical beam-forming units 2. These three optical beam-forming units form a part of a laser control system (not shown) as disclosed above in detail with reference to FIG. 8, and each one of the three optical beam-forming units 2 is configured to receive respective laser light, 115A, 115B, 115C, from the laser(s) (see item 108 of FIG. 8) of the laser control system. The laser control system is configured to receive a plurality of respective detection signals 14 from respective beam monitoring units of the three separate optical beam-forming units 2, and to generate a plurality of laser control signals (see item 106 of FIG. 8) according to the received detection signals 14 for controlling an optical power of respective laser light outputs 115A, 115B, 115C.

The 3D-MOT device 200 comprises three beam forming units 2 each being substantially identical in structure and function to the optical beam-forming apparatus disclosed herein with reference to FIGS. 1 to 7 (see item 2 of FIG. 1A), and each being configured to form a respective one of three collimated beams of linearly polarised light. Each optical beam-forming apparatus is further configured to convert its collimated beam of linearly polarised light into a respective collimated beam of circularly polarised light, by passing the collimated beam of linearly polarised light through a quarter-wave plate which converts the linear polarisation into a circular polarisation. This is achieved by fitting the quarter-wave plate (not shown) in the distal end of the device at an axial position after the cube mounting cartridge 38, in the direction of light propagation. The quarter-wave plate is held in place by a distal retaining ring (not shown). As noted above, the inner bore surface of the bore 32 of each respective optical beam-forming apparatus is threaded with a threading configured to reciprocate a threading formed on an outer circumferential edge of the distal retaining ring. This retaining ring is ‘screwed down’ onto an opposing surface of the quarter-wave plate such that the quarter-wave plate is sandwiched between, and abutted against, the opposing surfaces of both the cube mounting cartridge 38 and the distal retaining ring.

The resulting three respective collimated beams of circularly polarised light, 117A, 117B, 117C, are used for manipulating cold atoms or cold molecules in a vacuum chamber 118 of the 3D-MOT.

Each beam-forming unit comprises a respective single-piece housing barrel unit 16 (not shown-see FIGS. 1A to 2C and 7) contained within a respective sheath cover part 4 and which houses optical and electronic components as discussed in more detail above. An input end of each of the three beam-forming units comprises a respective input/output socket port 6 of a single cable interface (e.g., a USB-C interface in this example) forming a part of the electronics housed by the respective beam-forming unit, which is configured for receiving power 12 from an external power source and for transmitting the detection signal 14 to an external signal receiver (not shown). The input end of each of the three beam-forming units also comprises a respective optical input port to which a respective fibre-optic cable connector is connected to an optical output end of a respective polarisation-maintaining optical fibre 20 along which a respective laser light signal 115 travels for input to the beam-forming unit in question. An opposite end of each beam-forming unit comprises an optical output port, as described above but not visible in FIG. 11, in the form of the open end of the respective bore (see item 32 FIG. 2B) that passes along the longitudinal axis of each of the three beam-forming units from its respective optical input port to its optical output port. The respective multiple optical components of each one of the three the optical beam-forming units 2 are housed within the respective single-piece housing barrel unit along the bore axis of the respective bore. As discussed in detail above, this defines an optical axis (see item 52 of FIG. 2C) that is coincident with the bore axis.

The optical axis (see item 52, FIG. 2C) of each one of the three optical beam-forming units 2 is orientated relative to a respective retro-reflection mirror assembly, 119A, 120A; 120B, 120C, mounted upon the 3D-MOT chamber 118. Each one of the three optical beam-forming units 2 is mounted upon the 3D-MOT chamber 118 via a respective one of three ‘tip/tilt’ translation stages, 116A, 116B, 116C, configured to permit adjustment of the position of the optical axis of the optical beam-forming units mounted upon it, in a two-dimensional plane perpendicular to the optical axis thereby to position the optical axis in question relative to the respective retro-reflection mirror assembly as necessary to cause the three optical axes to converge at a location within a centre of the vacuum chamber. Three pairs of counter-propagating optical beams of light, 117A, 117B, 117C are thereby also caused to converge at a location within a centre of the vacuum chamber, in use. It is to be understood that the optical axis of any one or more of the three optical beam-forming units 2 may be a ‘folded’ optical axis such as is the case with the optical axis of one of the optical beam-forming units 2 illustrated in FIG. 11, whereby the respective retro-reflection mirror assembly comprises a first mirror unit 119A and a second mirror unit 120A. The first mirror unit is configured to fold (i.e., change the direction of) the optical axis of the associated optical beam-forming unit to a direction intersecting the second mirror unit such that retro-reflection from the second mirror unit can take place. The counter-propagating optical beams of light, 117A, created by this folded optical arrangement are thereby also folded.

The vacuum chamber 118 of the 3D-MOT contains a magnetic field apparatus comprising three pairs of magnetic field coils, 125, 126, 127, arranged for generating a magnetic field at a location within a centre of the vacuum chamber that is configured to concentrate gas atoms or molecules cooled or manipulated using the three optical beam-forming units 2. The three optical beam-forming units, in conjunction with the retro-reflection mirror assembly, thereby provide six laser beams consisting of three pairs of counter-propagating optical beams of light, 117A, 117B, 117C for use in manipulating cold atoms or cold molecules. The magnetic field generated by the three pairs of magnetic field coils, 125, 126, 127, together with the three pairs of counter-propagating optical beams of light, 117A, 117B, 117C, create a magneto-optical trap (MOT). In this way, the retro-reflection mirror assembly, 119A, 120A; 120B, 120C, is configured for creating six laser beams necessary for 3D confinement of the atoms the vacuum chamber 118 of the 3D-MOT.

Note that, in the present example, the three optical beam-forming units 2 are attached to this structure via the three ‘tip/tilt’ translation stages, 116A, 116B, 116C, which may be used subsequently to optimise the alignment of the optical beams of light, 117A, 117B, 117C. The ‘tip/tilt’ translation stages provide rotation about the x and y axes where z is the direction of propagation of the optical beams of light, 117A, 117B, 117C. However, in other examples, the vacuum chamber 118 of the MOT may be made and sold without one or more of the optical beam-forming units 2 yet attached to a respective translation stage, 116A, 116B, 116C, such that the user may subsequently mount the one or more of the optical beam-forming units 2. In such a case, the respective translation stage may be pre-set in a pre-aligned state according to the expected position that an optical axis of an optical beam-forming unit 2 will assume when the optical beam-forming unit is coupled to that translation stage in a pre-defined coupling position thereon. This is possible due to the high degree of consistency with which the optical axis of a given optical beam-forming unit can be positioned relative to the chassis 16 of that unit in manufacture such that the user can be confident that by simply mounting the optical beam-forming unit at the pre-defined coupling position upon the translation stage pre-set in its pre-aligned state, the optical axis of that optical beam-forming unit will also achieve an aligned state suitable for generating the pairs of counter-propagating optical beams of light, 117A, 117B, 117C, without themselves needing to perform beam alignment using the translation stages.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations. Any section headings used herein are for organizational purposes only and are not to be construed as limiting the subject matter described. Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%. The term “about” when used in this specification refers to a tolerance of +10%, of the stated value, i.e. about 50% encompasses any value in the range 45% to 55%, In further aspects or embodiments “about” refers to a tolerance of ±5%, ±2%, ±1%, ±0.5%, ±0.2% or 0.1% of the stated value.

1. An optical beam-forming apparatus for forming a collimated beam of linearly polarised light from input light received thereby, the apparatus comprising:
a chassis supporting a plurality of component units, the plurality of component units comprising:
a collimation lens unit configured to produce a collimated beam of light from the input light; a polarisation control unit configured to impose a pre-set minimum degree of linear polarisation upon the collimated beam of light; a beam splitter unit configured to extract a monitoring portion of light from the collimated beam of light; wherein the chassis is shaped to support each one of the collimation lens unit, the polarisation control unit and the beam splitter unit so as to secure their respective positions in a mutual coaxial alignment along an optical axis of the beam-forming apparatus; and,
a beam monitoring unit configured to receive the monitoring portion of light and to produce a monitoring signal corresponding to an optical intensity thereof for use in monitoring an optical intensity of the collimated beam of light according to the optical intensity of the monitoring portion of light.

2. The optical beam-forming apparatus according to claim 1 wherein the chassis comprises a single-piece housing within which is housed one or more of: the collimation lens unit; polarisation control unit; the beam splitter unit.

3. The optical beam-forming apparatus according to claim 1 wherein the chassis is shaped to provide an interface formation engaging simultaneously with a reciprocally-shaped interface formation provided by a respective shape of each one of the collimation lens unit, the polarisation control unit and the beam splitter unit.

4. The optical beam-forming apparatus according to claim 3 wherein the interface formation is shaped to define a bore to a surface with which each of the respective reciprocally-shaped interface formations engage to position, respectively, the collimation lens unit, the polarisation control unit and the beam splitter unit in positions in succession along an axis of the bore.

5. The optical beam-forming apparatus according to claim 4 wherein the chassis includes securing parts comprising one or more fixing rings configured to engage simultaneously with the bore and with at least one of the component units to secure the position(s) of the at least one component unit along the axis of the bore.

6. The optical beam-forming apparatus according to claim 1 configured for receiving said input light from an optical fibre and further comprising a terminated fibre adapter unit secured to the chassis and configured for connecting to a pre-terminated end of an optical fibre to secure an output end of the optical fibre to the chassis.

7. The optical beam-forming apparatus according to claim 1 wherein the polarisation control unit is located between the collimator unit and the beam splitter unit for receiving the collimated beam of light from the collimator unit, for imposing said pre-set minimum degree of linear polarisation thereupon, and for directing a linearly-polarised collimated beam of light to the beam splitter unit.

8. The optical beam-forming apparatus according to claim 1 wherein the beam splitter unit comprises a cube beam-splitter.

9. The optical beam-forming apparatus according to claim 8 wherein the optical beam-forming apparatus defines an optical axis along which the collimated beam of light is formed to extend, and the cube beam-splitter comprises a partially reflective internal beam-splitting optical surface inclined between two external optical faces of the cube beam-splitter both of which are substantially perpendicular to the optical axis.

10. The optical beam-forming apparatus according to claim 1 further comprising a housing through which a continuous bore extends containing the collimation lens unit, the polarisation control unit, and the beam splitter unit each received therein to collectively define a mutual optical axis for transmission of the beam of collimated light along the bore, wherein an axis of the bore coincides with the mutual optical axis.

11. The optical beam-forming apparatus according to claim 10 in which the bore comprises a circular cross section defining a bore surface with a radius of curvature, wherein the collimation lens unit, the polarisation control unit, and the beam splitter unit each comprise respective outer surface parts possessing said radius of curvature therewith forming a contact interface with the bore surface permitting positional adjustment thereof axially along the mutual optical axis.

12. The optical beam-forming apparatus according to claim 10 in which the housing comprises a fibre-optic adaptor unit for receiving an output end of an optical fibre and for fixing the position thereof relative to the fibre-optic adaptor unit, wherein the position of the fibre-optic adaptor unit is adjustable in directions transverse to the bore and/or is adjustable azimuthally about the optical axis to adjust the position of the output end of an optical fibre to align with the mutual optical axis.

13. The optical beam-forming apparatus according to claim 12 wherein the collimation lens unit defines an optical axis along which the beam of collimated light is formed to extend, and the polarisation control unit comprises a polarising cube beam-splitter comprising a polarisation-dependent reflective internal optical surface inclined between two external optical faces of the polarising cube beam-splitter both of which are substantially perpendicular to the optical axis, wherein the orientation of the fibre-optic adaptor unit is adjustable azimuthally about the optical axis relative to the polarisation-dependent reflective internal optical surface.

14. The optical beam-forming apparatus according to claim 1 wherein the beam monitoring unit comprises a photodiode for receiving the monitoring portion of light and for generating an electrical current signal in response thereto, and an amplifier unit configured to receive the electrical current signal and to generate a voltage signal in response thereto, and to output the result as said detection signal.

15. The optical beam-forming apparatus according to claim 1 wherein the beam monitoring unit comprises a single cable interface configured for receiving power from an external power source and for transmitting the detection signal to an external signal receiver.

16. The optical beam-forming apparatus according to claim 1 configured to receive laser light from a laser unit and to form the beam of collimated light using the received laser light, and further comprising a control unit for receiving the detection signal from the beam monitoring unit and for generating a laser control signal according to the received detection signal for controlling an optical power output of the laser unit.

17. The optical beam-forming apparatus according to claim 16 wherein the control unit is configured to provide power to the beam monitoring unit.

18. The optical beam-forming apparatus according to claim 16 further comprising the laser unit.

19. A system comprising a plurality of optical beam-forming apparatuses according to claim 18 and further comprising:
a plurality of respective lasers;
a control unit for receiving a plurality of detection signals from respective beam monitoring units and for generating a plurality of laser control signals according to the received detection signals for controlling an optical power output of respective laser units.

20. The system according to claim 19 further comprising:
a magnetic field apparatus for providing a magnetic field arranged to concentrate gas atoms or molecules cooled or manipulated using the optical beam-forming apparatus, wherein the plurality of the optical beam-forming apparatuses is for providing one or more pairs of counter-propagating optical beams of light for manipulating cold atoms or cold molecules, and wherein the magnetic field and the one or more pairs of counter-propagating optical beams of light create a magneto-optical trap (MOT).
